(19) United States
(12) Patent Application Publication
(10) Pub. No.: US 2022/0015217 A1
(43) Pub. Date: Jan. 13, 2022

(54) Electrical Noise Reduction in Personal Grounding Systems

(71) Applicants: Brian Hearing, Falls Church, VA (US); Laura Koniver, Fort Mill, SC (US)

(72) Inventors: Brian Hearing, Falls Church, VA (US); Laura Koniver, Fort Mill, SC (US)

(21) Appl. No.: 17/120,136

(22) Filed: Dec. 12, 2020

Related U.S. Application Data
(60) Provisional application No. 63/050,196, filed on Jul. 10, 2020.

(51) Int. Cl. H05F 3/02

(52) U.S. Cl. CPC H05F 3/02

(57) ABSTRACT

A system, method, and apparatus for reducing or isolating electric noise in personal grounding systems. An example method includes placing a diode between the personal grounding device and the grounding circuitry of a structure. The method also includes modifying or tuning the electrical components to specifically reduce bands of noise present in different circuits (60 Hz in North America versus 50 Hz in Europe, for example). The method further includes enclosing the components within the cord of the personal grounding system or a separate enclosure that would be plugged in serial between the personal grounding device and the structure's grounding circuitry. The method moreover includes a variety of different physical plug types including round pins or flat blades to adapt to any existing electrical outlet around the world.

This application claims priority to pending provisional application Ser. No. 63/050,196 filed on Jul. 10, 2020 the disclosure of which is hereby incorporated by reference.

### FIELD OF THE INVENTION

The invention relates to the process of reducing electrical noise in personal grounding systems.

### BACKGROUND OF THE INVENTION

Personal grounding devices provide a way to directly connect a user's body to the earth and enable electrical discharge off the human body. This is often accomplished by electrically connecting conductive or inductive items in contact with the body (such as a grounding bracelet or blanket, for example) to a structure's electrical grounding system (such as the ground plug in an electrical outlet).

However, many other electrical devices in structures are also in contact or close proximity with the structure's grounding system. This can often introduce electrical interference in the grounding wires that can cause noise, hum, and other interferences (a common example is the 50-60 Hz hum that is audible in audio systems). Grounding devices connecting a human body to the electrical outlet ground may thus be introducing electrical noise from that structure's ground wire back to the user of the personal grounding device. Thus, there is a need for a process to reduce electrical noise propagating from a structure's grounding system back through any connected personal grounding systems.

For example, FIG. 1 shows a commercially available personal grounding system that uses a wrist strap 1 to connect a human user 2 to the grounding circuit 3 of the electrical system of a structure 4. Noise 5 introduced by other electrical devices 6 connected to the same grounding circuit 3 can propagate back to the human user 2. Sometimes, such a system includes a resistor 7 to prevent electrical shocks back to the human, but such resistors do not prevent electrical noise 5 in grounding circuit 3 from reaching the human user 2. Some humans are sensitive to such electrical noise and feel irritation and/or discomfort when exposed to such electrical noise.

Many devices and patents exist for reducing ground noise interference; however, they are usually designed for audio systems and computers. For example, U.S. Pat. No. 3,394,269 describes a system for cancellation of ground loop effects in a system employing low level intelligence signals. U.S. Pat. No. 5,901,098 describes a ground noise isolation circuit for semiconductor memory devices. Patent search does not indicate any previous art specifically focused on grounding devices where goal is to reduce propagation of ground noise of concern back to humans.

Patents on personal body grounding systems do not discuss reducing noise in the grounding circuit. Some rely on separate conduits to the ground, bypassing the grounding circuitry of the structure. For example, U.S. Pat. Nos. 6,683,779, 7,212,392, 2014/259,398, 2015/107,022, and 2015/321,047 describe personal grounding systems that connect directly to the earth. While this reduces introducing structural ground system noise to the human body, it still can induce noise via EMF induction and connect that back to the human. Some rely on direct connections to a structure's grounding circuitry, such as US Patent 2008/68,773, U.S. Pat. No. 7,724,491, and 2013/33,121. However, these systems do not include any noise rejection components and suffer from introducing ground circuit noise to the human as described above.

Many patents discuss static discharge with the goal of preventing shock from humans to workpieces such as electronics. For example, U.S. Pat. Nos. 4,373,175 and 4,800,374 describe devices with the goal of preventing damage from a statically charged human to electrostatic sensitive equipment. However, these do not include filters preventing noise in the grounding system from propagating back to the human.

Other patents discuss ‘clean electricity’, IE removing interference from active voltages that supply power to electronics. For example, U.S. Pat. No. 5,448,442 describes a power conditioning device and method. U.S. Pat. No. 6,914,435 describes measuring electrical pollution on power lines. This present disclosure is different since we seek only to isolate the ground plug and wiring of the earth ground circuit, not the actual power supply.

Ground isolators are commercially available components used in audio equipment. For example, US Patent 2011/268,289 describes ground loop noise rejection for a headset subsystem. However these patents are designed for electrical components and not humans and the electrical components used in them are usually not effective in filtering noise relevant to the human body.

Many patents discuss EMI shielding; for example, U.S. Pat. Nos. 3,594,491 and 5,414,211 describe cables shielded from electromagnetic interference with protective meshes. EMI shielding removes external EMI signals, however it does not protect the human user of a grounding device from EMI introduced by the grounding device itself (IE grounding blanket placed inside EMI bed shield, connected to ground via cable extending outside an EMI shield, could introduce EMI back into the area protected by the shield).

It is also common practice to place a resistor or fuse between the grounding device and the structure's grounding wiring to reduce shocks delivered to the human in case of lightning or an electrical component shorting. For example, U.S. Pat. No. 7,349,194 describes a variable resistor between the connection of the human to the ground. However, resistors and fuses do not reduce the interference noises present in the grounding circuit.

### SUMMARY OF THE INVENTION

It is an object of the invention to filter, remove, or block electronic noise in a personal grounding device before a human user is contacted by such electronic noise.

In accordance with this and other objects of the invention that will become apparent from the description herein, the present invention improves on existing grounding strap systems having a wrist strap configured to be worn by a human user that is electrically connected at a first end of an electrically conductive cord which is connected a second end of said cord to a connector configured to fit into an outlet having a grounding circuit, the improvement comprising: a diode that is electrically interposed between said grounding strap and said second end of the cord. Optionally, the grounding system can have a resistor between the diode and the connector to the existing building grounding circuit, e.g., a grounding line having a pair of nonconductive spade terminals sized to fit into a conventional wall outlet.

The present invention reduces or blocks user contact or exposure to electronic noise in grounding circuits from propagating back to the human user of the personal grounding device. One example of the present invention reduced 60 Hz noise in a residential grounding system by over 24 dB (linear factor of over 250 times). The 120 Hz harmonic was reduced by 22 dB (linear factor over 188 times) and the 240 Hz harmonic is reduced by over 15 db (linear factor over 37 times). Such reductions in line noise increase the comfort of those users who are sensitive to or made uncomfortable by such electrical currents.

### BRIEF DESCRIPTION OF THE DRAWINGS

FIG. 1 is an illustration of a prior art personal grounding device circuit and how electrical noise in grounding lines can propagate back to humans using such devices.

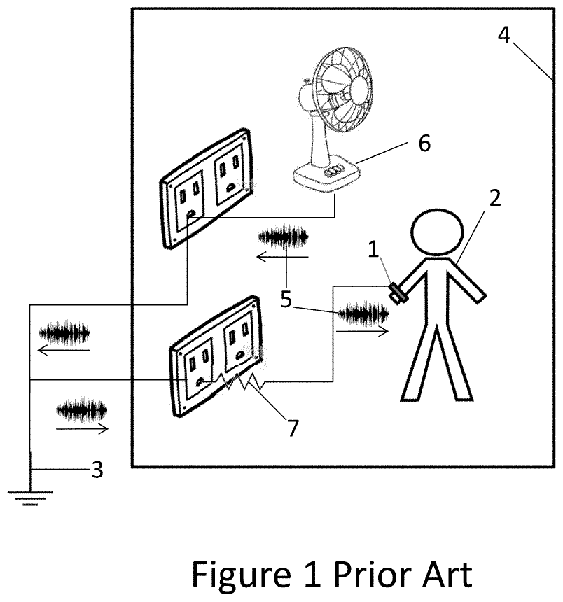

FIG. 2 shows a diagram of the present device and its circuit that blocks electrical noise in in grounding lines attached to a human user by a grounding strap from propagating back to the user.

FIG. 3 compares spectra of personal grounding systems without (A) and with (B) the invention of the present disclosure. The spectra of the invention (line B) has been offset by 20 dB to show the differences more clearly.

FIG. 4 shows spectrograms of personal grounding devices without (A) and with (B) the present invention.

### DETAILED DESCRIPTION OF THE INVENTION

The present disclosure can be embodied either directly in the electrical cord that connects the user wrist strap to the grounding lines inside conventional wall and floor outlets (in-line embodiment).

An alternative system is an adapter plug having one end to receive a conventional spade plug from a conventional grounding strap and interposes the diode and optionally a resistor, between the receiving connection and the inserted connectors that contact the grounding circuit in the existing wall outlet (plug-in embodiment).

The noise reduction circuitry for either the in-line or plug-in embodiments can range from one or more serially disposed diodes to more complex filters involving capacitor-inductor filter loops or transistor-based rectifiers, for example. The embodiments can be placed anywhere along the grounding line, IE either close to the human user or closer to the connection to ground.

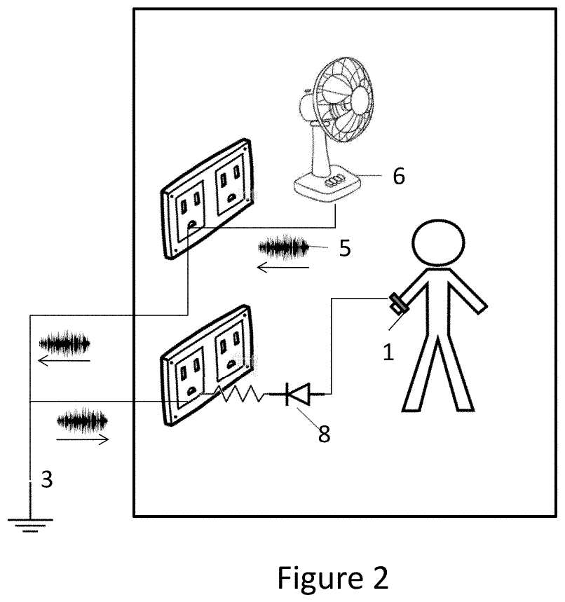

The example personal grounding device noise reduction disclosure of FIG. 2 and according to the invention is configured to reduce electrical noise in the grounding system. The example electrical noise reduction device is also configured to work between existing, non-reduced personal grounding devices via a plug-in adapter. The electrical noise reduction device may include a self-contained apparatus that may be positioned at any location on a user's personal grounding device, structural grounding system, or stand-alone grounding circuitry. The electrical noise reduction device may include an exterior casing that is constructed from metal, hard plastic, soft plastic, and/or a combination thereof. In some instances, the electrical noise reduction device may be water-tight to enable deployment out-doors.

Noise Reduction Components:

A preferred personal grounding device noise reduction system according to the invention includes electrical components to reduce noise present in grounding circuitry. The components may include, for example, a diode to prevent charge or currents from propagating back to the user of the personal grounding system. In other embodiments, the circuitry may include capacitor-inductor filter loops or transistor-based rectifiers, for example. These components must be designed specifically for human grounding electricity levels, including allowing low levels of voltage potential and current to propagate from the human user to the structural ground circuit, but also preventing high frequency noise present in the structural ground circuitry from propagating back to the human. Other design considerations could include allowing passage of Schumann Resonances (7.83 Hz) for example, if desired by the user. FIG. 5 shows a diagram of the noise reduction circuitry described in the current disclosure placed between the personal grounding device and the structure's grounding circuitry.

The present disclosure applies electrical isolation circuitry to personal grounding systems to reduce electrical noise from reaching the human user, as illustrated in FIG. 2. As shown in that figure, wrist strap 1 connects a human user 2 to the grounding circuit 3 of the electrical system in structure 4, such as a house, office, or workshop. Noise 5 is generally inherently introduced by other electrical devices 6 connected to the same grounding circuit 3 can propagate back to the human user 2. Sometimes, such a system includes a resistor 7 to prevent electrical shocks back to the human.

### Examples

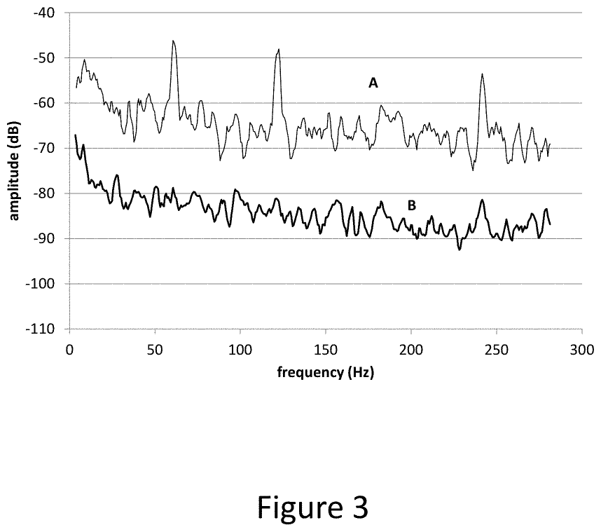

Example 1 is a comparison of the effectiveness of the improvements found in the present invention compared to the same fundamental system but without the diode of the present invention. FIG. 3 displays electronic signal spectra reaching the grounding strap on grounding systems without (line A) and with (line B) the present invention. The system of the present invention reduces 60 Hz electronic noise by over 24 dB, i.e., a linear factor of over 250 times. When electrical isolation circuitry is applied according to the invention, the reduction in noise propagating back to the human is dramatic.

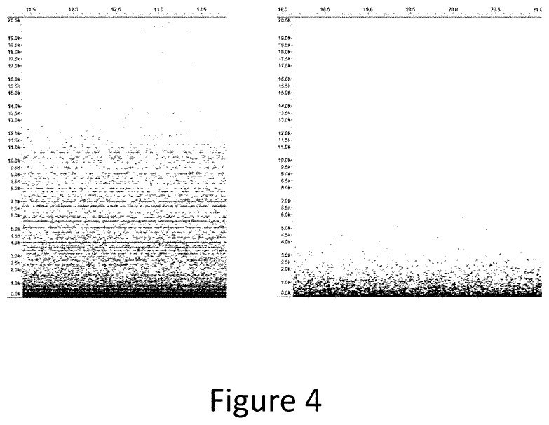

FIG. 4 is a display of the system harmonics without present disclosure (left side) has harmonics visible up to 20 kHz. With the present invention, none are visible as shown by the spectra on the right.

In some embodiments the noise reduction components may be integrated directly into the ground cord or plug of the personal grounding system. In other embodiments the noise reduction components may be enclosed in a separate unit that would be positioned between existing personal body grounding devices and the structural grounding register. This would enable other personal grounding devices that do not include the present disclosure to still receive the benefit of the present disclosure when used in serial.

Components can be designed or optimized for different types of noise present in structural circuitry, for example 50 Hz in European countries, or specific frequency filters for structures that include specialized electrical devices that emit special types of electrical noise.

Mechanical design can include configurations for different plugs, for example round used in some parts of the world versus blades used in the United States.

The examples provided in this disclosure do not preclude other electrical configurations that can provide noise rejection in personal grounding devices. Those skilled in art will recognize that other configurations can exist.

This disclosure also covers an adapter plug containing the disclosed electronics, which could be used between other grounding products and the structure's ground circuit, e.g., an adapter that would apply the benefits of the disclosure to other grounding products.

Additional features and advantages of the disclosed system, method, and apparatus are described in, and will be apparent from, the following detailed description and the figures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. In a process for reducing human user exposure to electrical noise in a personal grounding device having a grounding strap physically connected at a first end to a human user and electrically connected at a second end of a connecting cord to a grounding circuit of a building, the improvement comprising:
electrically interposing a diode between the grounding strap and said grounding circuit of said building.

2. A process according to claim 1 wherein said personal grounding device further comprises a resistor between said diode and said second end.

3. A process according to claim 2 wherein said resistor and said diode are selected or tuned to block 60 Hz signal noise.

4. A process according to claim 1 wherein the components are embodied either within the cord of the personal grounding device or a separate unit plugged in serial between the grounding strap and said grounding circuit.

5. In a personal grounding device comprising a wrist strap configured to be worn by a human user that is electrically connected at a first end of an electrically conductive cord which is connected a second end of said cord to a connector plug configured to fit into an outlet having an installed grounding circuit, the improvement comprising:
a diode that is electrically interposed between said grounding strap and said grounding circuit.

6. A grounding device according to claim 5 wherein said diode is adjacent said first end.

7. A grounding device according to claim 5 wherein said diode is located between said plug and said grounding circuit.
